(19) United States
(12) Patent Application Publication
(10) Pub. No.: US 2025/0291701 A1
(43) Pub. Date: Sep. 18, 2025

(54) METHOD FOR CONSTRUCTING A QUALITY EVALUATION DATA UPDATING MODEL BASED ON A CONVOLUTIONAL NEURAL NETWORKS

(71) Applicant: China National Institute of Standardization, Beijing (CN)

(72) Inventors: Yuwei Lu, Beijing (CN); Wenru Gong, Beijing (CN); Jingna Yang, Beijing (CN); Jingxing Liao, Beijing (CN)

(21) Appl. No.: 18/830,489

(22) Filed: Sep. 10, 2024

(30) Foreign Application Priority Data
Mar. 15, 2024 (CN) 202410297455.8

(51) Int. Cl. G06F 11/34

(52) U.S. Cl. CPC G06F 11/3495

(57) ABSTRACT

The present invention relates to the data updating technology, disclosing a method for constructing a quality evaluation data updating model based on a convolutional neural network including: collecting historical data of product quality evaluation from an original quality evaluation model, determining the update frequency of quality evaluation data of original model; obtaining the latest quality evaluation data for data update of model based on the historical data of product quality evaluation; establishing a first data sample set and a second data sample set to update the model; and conducting model performance testing on the original model with such updated data to determine the effectiveness evaluation results of the data updates. The present invention updates the data samples of the quality evaluation model by determining the data update frequency of the model, and improves the performance and accuracy of the model by evaluating the effectiveness of the data updates.

### CROSS-REFERENCE TO RELATED APPLICATION

This application claims priority of Chinese Patent Application No. 202410297455.8, filed on Mar. 15, 2024, the entire contents of which are incorporated herein by reference.

### TECHNICAL FIELD

The present invention relates to the field of data updating technology, to be more specific a method for constructing a quality evaluation data updating model based on convolutional neural networks.

### BACKGROUND TECHNOLOGY

Convolutional neural networks, as a type of deep learning model, have found extensive applications in various domains such as image recognition, object detection, and image classification. In terms of quality evaluation data updating technology, the role of convolutional neural network is to effectively extract product features and automatically evaluate the quality. With the advancement of the information age, there is an increasing demand for product quality evaluation, while the evolution of product quality evaluation models is accelerating. Therefore, it is essential to provide a method for constructing a quality evaluation data update model based on convolutional neural networks, which can be utilized to timely update the product quality evaluation data from the quality evaluation model, thereby guaranteeing the accuracy of product quality evaluation.

Taking the invention patent (publication number: CN107229966B) as an example, which discloses a method for updating model data and its device and system. This method can be utilized to improve model training efficiency. More precisely, the method for updating model data illustrated in the present application consists of: determining the model data that needed to be updated in multiple slaves by the master; then, dividing the determined model data into N sets, and sending these data to the first slave among the multiple slaves separately, then, transferring such N sets of the model data among these multiple slaves. When the first slave receives the M^{th} set of model data, it sends the model data from the previous M-1 sets which have not yet been sent out to the next slave. In the present application scheme, the master is only required to send model data to one of the slaves, which will then send the received model data to the next slave while receiving it. It contributes to not only saving bandwidth resources and system resources for the master, but also reducing the time needed for model data updating, thereby improving the model training efficiency.

According to the above scheme, it is found that there are still some shortcomings in data updating, which are reflected in the following aspects: (1) Currently, accurately evaluating the correspondence between the performance of quality evaluation models and time consumption is impossible, and determining the data update frequency of the model is challenging, which may result in failing to timely update data or making data update too frequently, leading to a decrease in model accuracy or resource waste.

At present, the update result of the first data sample set in the quality evaluation model is insufficiently accurate to determine the dependence of the model on the first data sample set and its importance. Inaccurate updates to the first data sample set may result in a decrease in model accuracy after data updates.

### SUMMARY OF THE INVENTION

In response to the shortcomings of existing technology, the present invention provides a method for constructing a quality evaluation data update model based on convolutional neural networks, which can effectively solve the problems involved in the aforesaid background technology.

For the above purpose, the present invention can be implemented through the following technical scheme: the present invention provides a method for constructing a quality evaluation data update model based on convolutional neural networks, comprising: collecting historical data of product quality evaluation of an original quality evaluation model, and analyzing the historical data of product quality evaluation of the original quality evaluation model, then, determining the update frequency of the quality evaluation data of the original quality evaluation model.

Obtaining the latest quality evaluation data used to update data of the original quality evaluation model based on the historical data of product quality evaluation, then, establishing a first data sample set and a second data sample set, and screening the first data sample set; after that, labelling the selected historical data sample elements as effective historical data sample elements, and updating the data of the original quality evaluation model according to the second data sample set, and various effective historical data sample elements, as well as the update frequency of quality evaluation data, wherein, the first data sample set represents the quality evaluation data sample set stored in the original quality evaluation model, while the second data sample set represents the new quality evaluation data sample set generated after the latest update of the data by the original quality evaluation model.

Labelling the updated quality evaluation model as a new quality evaluation model and conducting model performance testing to determine the effectiveness evaluation results of the quality evaluation data update.

As a further method, the specific analysis process for analyzing the historical data of product quality evaluation of the original quality evaluation model is as follows: deriving the accuracy rates, the F1 scores, and the ROC-AUC values of the original quality evaluation model in each period through processing based on the historical data of product quality evaluation from the original quality evaluation model, including the predicted and actual results of product quality evaluation.

Conducting regression analysis on the accuracy rates, the F1 scores, and the ROC-AUC values of the original quality evaluation model in each period to derive the quality evaluation factor for accuracy indices, the quality evaluation factor for F1 score indices, and the quality evaluation factor for ROC-AUC value indices, respectively.

Obtaining the comprehensive performance evaluation parameter of the original quality evaluation model through comprehensive analysis.

As a further method, the specific process of determining the update frequency of quality evaluation data of the original quality evaluation model is as follows: extracting the initial comprehensive performance evaluation parameter of the original quality evaluation model from the data update cloud platform, subtracting the initial comprehensive performance evaluation parameter from the comprehensive performance evaluation parameter, and labelling the obtained difference as the performance change evaluation parameter of the original quality evaluation model.

Comparing the performance change evaluation parameter of the original quality evaluation model with the update frequency of quality evaluation data corresponding to various performance change evaluation parameter ranges stored in the data update cloud platform, and thus the update frequency of quality evaluation data of the original quality evaluation model is obtained.

As a further method, the specific process of screening the first data sample set is as follows: Dividing the first data sample set and the second data sample set according to the preset geographical ranges, and obtaining the collection membership geographical ranges of various historical data sample elements and the number of new data sample elements within each geographical range, and thus the specificity evaluation indices of various historical data sample elements are obtained through processing.

Collecting the interval durations since the acquisition time of various historical data sample elements till the current quality evaluation data update, and labelling them as the time span among those historical data sample elements, after that, conducting a comprehensive analysis to obtain the weight index for screening the said historical data sample elements.

Comparing the weight indices for screening various historical data sample elements with the preset threshold for screening weight indices of historical data sample elements. If certain weight index for screening historical data sample elements is less than the threshold for screening weight indices of historical data sample elements, the historical data sample element corresponding to such weight index for screening historical data sample elements shall be deleted. Otherwise, if a weight index for screening historical data sample elements is greater than or equal to the threshold for screening weight indices of historical data sample elements, the historical data sample element corresponding to such weight index for screening historical data sample elements shall be retained.

As a further method, conducting model performance testing to determine the effectiveness evaluation results of the quality evaluation data updates, the specific process is as follows: conducting performance tests on the original quality evaluation model and the new quality evaluation model respectively, and thus the accuracy rates, the F1 scores, and the ROC-AUC values of the original quality evaluation model and the new quality evaluation model are obtained. After that, the comprehensive performance reference indices of the original model and the new model can be generated through processing.

Extracting comprehensive performance critical evaluation index of the new model from the data update cloud platform, then, comparing the comprehensive performance reference index of the new model with the comprehensive performance reference index of the original model and the comprehensive performance critical evaluation index of the new model respectively. If the comprehensive performance reference index of the new model is less than the comprehensive performance reference index of the original model, or if the comprehensive performance reference index of the new model is less than the comprehensive critical evaluation index of the new model performance, the data update will be determined as failed, and the quality evaluation data of the original quality evaluation model shall be re-updated, if the comprehensive performance reference index of the new model is greater than or equal to the comprehensive performance reference index of the original model and the comprehensive performance critical evaluation index of the new model, the data update will be determined as successful, and the comprehensive performance reference index of the new model shall minus the comprehensive performance reference index of the original model and the comprehensive performance critical evaluation index of the new model, respectively, to thus the effectiveness evaluation index of data update can be obtained through analysis.

Comparing the effectiveness evaluation index of data update with the preset threshold of effectiveness evaluation indices of data update. If the effectiveness evaluation index of data update is greater than or equal to the threshold of effectiveness evaluation indices of data update, labelling the current effectiveness evaluation result of data update as an effective update. Otherwise, if the effectiveness evaluation index of data update is less than the threshold of effectiveness evaluation indices of data update, labelling the current effectiveness evaluation result of data update as an ineffective update.

As a further method, the comprehensive performance evaluation parameter of the original quality evaluation model is a quantized evaluation data generated by analyzing the quality evaluation factor for accuracy indices, the quality evaluation factor for F1 score indices, and the quality evaluation factor for ROC-AUC value indices. It can be used to quantitatively evaluate the time-effectiveness of the model performance in terms of accuracy rate, F1 score, and ROC-AUC value, thus providing data basis for determining the data update frequency of the model.

As a further method, the weight index for screening historical data sample elements is a quantized evaluation data generated by analyzing the specificity and time-effectiveness of historical data sample elements. It can be used to quantitatively evaluate the dependence of the model on historical data sample elements and the importance of historical data sample elements, thereby providing data basis for screening the first data sample set.

As a further method, the computation expression for the comprehensive performance evaluation parameter of the original quality evaluation model is as follows:

$$β = {log}_{2} ( \sqrt{\frac{{α}_{Z} * {ζ}_{1} + {α}_{F} * {ζ}_{2} + {α}_{R} * {ζ}_{3}}{e}} + 1 ) ,$$

wherein, β refers to the comprehensive performance evaluation parameter of the original quality evaluation model, e refers to the natural constant, α_{Z} refers to the quality evaluation factor for accuracy indices, α_{F} refers to the quality evaluation factor for F1 score indices, α_{R} refers to the quality evaluation factor for ROC-AUC value indices, ζ₁ refers to the comprehensive performance impact weight corresponding to the given quality evaluation factor for the accuracy indices, ζ₂ refers to the comprehensive performance impact weight corresponding to the given quality evaluation factor for F1 score indices, and ζ₃ refers to the comprehensive performance impact weight corresponding to the given quality evaluation factor for ROC-AUC value indices.

As a further method, the computation expression for the weight indices for screening various historical data sample elements is as follows:

$${χ}_{i} = ln [ {( \frac{1}{e} )}^{\sqrt{\frac{1}{{δ}_{i} * {ψ}_{1}} + {T}_{i} * {ψ}_{2}}} + 1 ] ,$$

wherein, χᵢ refers to the weight index for screening the i^{th} historical data sample element, δᵢ refers to the specificity evaluation index of the i^{th} historical data sample element, Tᵢ refers to the time span of the i^{th} historical data sample element, ψ₁ refers to the screening weight impact factor corresponding to the given specificity evaluation index of the historical data sample element, ψ₂ refers to the weight impact factor for screening per unit corresponding to the given time span of the historical data sample element, i refers to the serial number of each historical data sample element, i.e., i=1,2,3, . . . , n and n refers to the total number of historical data sample elements.

Compared with the prior art, the embodiments of the present invention have at least the following advantages or beneficial effects:

(1) The present invention provides a method for constructing a quality evaluation data update model based on convolutional neural networks. By analyzing the time-effectiveness of the performance of the quality evaluation model, this method may determine the data update frequency of the quality evaluation model and update the data samples in the model, as well as evaluate the effectiveness of the updated quality evaluation data by analyzing the comprehensive performance of the quality evaluation model after the data update. In addition, it allows for further optimization and iteration of the model through evaluating the effectiveness of the data update, thereby improving its performance and accuracy.

(2) The present invention is capable of determining the data update frequency of the quality evaluation model by analyzing the time-effectiveness of the performance of the quality evaluation model and reducing dependence of the model on specific data by regularly updating, thus, its generalization ability to different data can be improved, thereby enhancing the robustness of the model. In addition, regular updates of data would enhance the environmental adaptability of the quality evaluation model, and thus the accuracy of the product quality evaluation can be guaranteed.

(3) The present invention provides a basis for updating the first data sample set of the model by analyzing the specificity and time-effectiveness of the historical data sample elements of the model. It may reduce the risk of overfitting to existing data by updating the historical data, thereby making the model more flexible and adaptable to new data distributions.

(4) The present invention supports evaluating the effectiveness of the quality evaluation data updates by analyzing the comprehensive performance of the quality evaluation model after data updates, and guaranteeing further optimization and iteration of the model by evaluating the effectiveness of data updates, thereby improving the performance and accuracy of the model. In addition, if the data updates cause performance degradation, the update strategy can be timely rolled back or re-evaluated to reduce potential risks.

### BRIEF DESCRIPTION OF THE DRAWINGS

Further illustration of the present invention can be made by using the accompanying drawings, however, all the embodiments described in the drawings do not constitute any limitation on the present invention. For ordinary technical personnel in the art, other drawings can be obtained based on the following drawings without creative labor.

FIG. 1 is a schematic diagram of the method flow of the present invention.

### DETAILED DESCRIPTION OF THE EMBODIMENTS

The text below will provide a clear and complete description of the technical scheme employed in the embodiments of the present invention, in conjunction with the accompanying drawings. It is evident that the embodiments described are only a part of, not the whole, of the present invention. On the basis of the described embodiments of the present invention, all other embodiments obtained by those of ordinary skill in the arts without creative labor fall within the protection of the present invention.

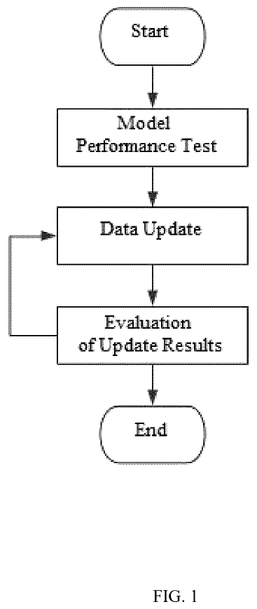

Referring to FIG. 1, the present invention provides a method for constructing a quality evaluation data update model based on convolutional neural networks, comprising: collecting historical data of product quality evaluation of an original quality evaluation model, and analyzing the historical data of product quality evaluation of the original quality evaluation model, then, determining the update frequency of the quality evaluation data of the original quality evaluation model.

To be more specific, the analysis process of analyzing the historical data of product quality evaluation of the original quality evaluation model is as follows: deriving the accuracy rates, the F1 scores, and the ROC-AUC values of the original quality evaluation model in each period through processing based on the historical data of product quality evaluation from the original quality evaluation model, including the predicted and actual results of product quality evaluation, wherein, the predicted results of the product quality evaluation, including the positive and the negative evaluations, refer to the quality evaluation of the product by the original quality evaluation model, and the actual result of product quality evaluation, including the positive and the negative evaluations, referred to the quality evaluation of the product by users after it is commercially available.

It should be understood that the original quality evaluation model described in this embodiment referred to the quality evaluation model before data update during a quality evaluation data update cycle. A quality evaluation model was an algorithm or system that comprehensively evaluated the quality of a product by collecting the product data. In terms of the practical application of the original quality evaluation model, it could generate product quality evaluation data, and then obtain the historical data of product quality evaluation of the original quality evaluation model based on statistics of the product quality evaluation data.

It should be understood that in this embodiment, the samples were divided into a predicted positive evaluation sample set and a predicted negative evaluation sample set according to the predicted results. Then, such samples were divided into an actual positive evaluation sample set and an actual negative evaluation sample set according to the actual results, wherein, the samples belonging to the actual positive evaluation sample set were labeled as actual positive examples, while those belonging to the actual negative evaluation sample set were labeled as actual negative examples. In addition, the samples within the intersection of the predicted positive evaluation sample set and the actual positive evaluation sample set were labeled as correctly predicted positive examples, and those within the intersection of the predicted negative evaluation sample set and the actual negative evaluation sample set were labeled as correctly predicted negative examples.

In a specific embodiment, the accuracy rates, the F1 scores, and the ROC-AUC values of the original quality evaluation model could be obtained not only by invoking built-in function analysis in statistical software and programming languages, but also through the following calculation methods. More precisely, the number of the correctly predicted positive samples N_{1→T}^{j}, the actual positive samples N_{T}^{j}, and the correctly predicted negative samples N_{1→F}^{j}, as well as the actual negative samples N_{F}^{j} in each period could be obtained based on the predicted and actual results of product quality evaluation, then, the accuracy rate of the original quality evaluation model for each period Accⱼ could be worked out by employing the calculation formula

$${Acc}_{j} = \frac{{N}_{1 \to T}^{j} + {N}_{1 \to F}^{j}}{{N}_{T}^{j} + {N}_{F}^{j}} ,$$

in addition, the recall rate of the original quality evaluation model for each period Recⱼ could be worked out by employing the calculation formula

$${Rec}_{j} = \frac{{N}_{1 \to T}^{j}}{{N}_{T}^{j}} ,$$

meanwhile, the F1 scores of the original quality evaluation model for each period F1ⱼ could be worked out by employing the calculation formula

$$F {1}_{j} = \frac{2 * {Acc}_{j} * {Rec}_{j}}{{Acc}_{j} * {Rec}_{j}} ,$$

and the true positive rates TPRₜⱼ and the false positive rates FPRₜⱼ of various positive samples for each period could be generated based on the predicted results of the original quality evaluation model, as well as the ROC-AUC values of the original quality evaluation model for each period AUCⱼ could be worked out by employing the calculation formula

$${AUC}_{j} = \frac{{{\sum }_{t = 1}}^{s} ( {TPR}_{tj} - {FPR}_{tj} )}{{N}_{T}^{j}} .$$

In the above formula, J referred to the serial number of each period, i.e. j=1,2,3, . . . , m, m referred to the total number of periods of time, t referred to the serial number of each positive sample, i.e. t=1,2,3, . . . , s and s referred to the total number of positive samples.

It should be understood that the accuracy rate referred to the ratio of positive and negative examples correctly predicted by the model, which could be employed to evaluate the overall performance of model, the F1 score referred to the harmonic mean of the accuracy rate and the recall rate, which could be employed to measure the accuracy and robustness of the model, and the ROC curve referred to a tool designed for binary classification, which was constructed by plotting true positive rate against false positive rate at different thresholds. In addition, the AUC value referred to the area measured according to the curve, representing the performance of the model for all possible thresholds. In conclusion, the comprehensive performance of the model could be accurately and comprehensively measured by analyzing and calculating the accuracy rates, the F1 scores, and the ROC-AUC values of the model.

Conducting regression analysis on the accuracy rates, the F1 scores, and the ROC-AUC values of the original quality evaluation model in each period to derive the quality evaluation factor for accuracy indices, the quality evaluation factor for F1 score indices, and the quality evaluation factor for ROC-AUC value indices, respectively.

In a specific embodiment, the quality evaluation factor for accuracy indices, the quality evaluation factor for F1 score indices, and the quality evaluation factor for ROC-AUC value indices could not only be analyzed by employing the learning curve to show the changes in performance indices of the model during the training process as the size of the training data sample set increases, but also could be employed show the predictions for different categories through the confusion matrix, wherein, the learning curve was utilized to observe whether the model has exhibited signs of overfitting or underfitting, while the accuracy of the model for certain categories could be determined through observing the confusion matrix. The aforesaid factors also could be worked out according to following calculation methods, i.e., conducting regression analysis on the accuracy rates, the F1 scores, and the ROC-AUC values of the original quality evaluation model in each period respectively, then, calculating the correlation coefficient corresponding to the accuracy rates, the F1 scores and the ROC-AUC values separately. Wherein, the calculation expression for the quality evaluation factor for accuracy indices is:

$${α}_{Z} = {[ \sqrt{{ξ}_{1} * ( 1 - {R}_{Z} ) + {ξ}_{2} * \frac{1}{m} {\sum }_{j = 1}^{m} \frac{\vert {Acc}_{j} - \frac{1}{m} {\sum }_{j = 1}^{m} {Acc}_{j} \vert}{\frac{1}{m} {\sum }_{j = 1}^{m} {Acc}_{j}}} ]}^{- 1} ,$$

wherein, α_{Z} referred to the quality evaluation factor for accuracy indices, R_{z} referred to the correlation coefficient corresponding to the accuracy rates, and ξ₁ referred to the quality evaluation impact factor for accuracy indices corresponding to the preset downward trend, as well as ξ₂ referred to the quality evaluation impact factor for accuracy indices corresponding to the preset fluctuation degree. Furthermore, the calculation expression of the quality evaluation factor for F1 score indices was:

$${α}_{F} = {[ \sqrt{{ω}_{1} * ( 1 - {R}_{F} ) + {ω}_{2} * \frac{1}{m} {\sum }_{j = 1}^{m} \frac{\vert F {1}_{j} - \frac{1}{m} {\sum }_{j = 1}^{m} F {1}_{j} \vert}{\frac{1}{m} {\sum }_{j = 1}^{m} F {1}_{j}}} ]}^{- 1} ,$$

wherein, α_{F} referred to the quality evaluation factor for F1 score indices, R_{F} referred to the correlation coefficient corresponding to the F1 score, ω₁ referred to the quality evaluation impact factor for F1 score indices corresponding to the preset downward trend, and ω₂ referred to the quality evaluation impact factor for F1 score indices corresponding to the preset fluctuation degree. In addition, the calculation expression of the quality evaluation factor for ROC-AUC value indices was:

$${α}_{R} = {[ \sqrt{{υ}_{1} * ( 1 - {R}_{R} ) + {υ}_{2} * \frac{1}{m} {\sum }_{j = 1}^{m} \frac{\vert {AUC}_{j} - \frac{1}{m} {\sum }_{j = 1}^{m} {AUC}_{j} \vert}{\frac{1}{m} {\sum }_{j = 1}^{m} {AUC}_{j}}} ]}^{- 1} ,$$

wherein, α_{R} referred to the quality evaluation factor for ROC-AUC value indices, R_{R} referred to the correlation coefficient corresponding to the ROC-AUC value, and υ₁ referred to the quality evaluation impact factor for ROC-AUC value indices corresponding to the preset downward trend, as well as υ₂ referred to the quality evaluation impact factor for ROC-AUC value indices corresponding to the preset fluctuation degree.

It should be understood that the correlation coefficient R in regression analysis could be invoked to measure the strength and direction of the linear relationship between two variables. More precisely, the value of R falls in between −1 and 1, with the value close to 1 indicating a strong positive correlation between variables, which meant that as one variable increases, the other variable would also significantly increase. Otherwise, the value close to −1 indicated a strong negative correlation between variables, meaning that as one variable increases, the other variable would also significantly decrease. In addition, the value close to 0 indicates that there was almost no linear correlation between variables, suggesting that changes in one variable would not significantly impact the other. Therefore, the downward trend of various indices of the model over time could be determined by the magnitude of the correlation coefficient, wherein, the closer R is to −1, the more apparent the downward trend of various indices in the model.

Obtaining the comprehensive performance evaluation parameter of the original quality evaluation model through comprehensive analysis.

To be more specific, the comprehensive performance evaluation parameter of the original quality evaluation model was a quantized evaluation data generated by analyzing the quality evaluation factor for accuracy indices, the quality evaluation factor for F1 score indices, and the quality evaluation factor for ROC-AUC value indices. It could be used to quantitatively evaluate the time-effectiveness of the model performance in terms of accuracy, F1 score, and ROC-AUC value, thus providing data basis for determining the data update frequency of the model.

In a specific embodiment, in addition to dividing a data sample set into multiple subsets by means of cross validation, and utilizing a part of such subsets as a validation set in turns and taking the rest as a training set to evaluate the performance of the model on independent data sample sets, the comprehensive performance evaluation parameter of the original quality evaluation model also could be utilized to evaluate the interpretability of the model's decision-making process by employing techniques such as SHAP SHapley Additive explanations) or LIME (Local Interpretable Model agnostic Explanations). It could be obtained through following calculation methods.

Further, the computation expression for the comprehensive performance evaluation parameter of the original quality evaluation model was as follows:

$$β = {log}_{2} ( \sqrt{\frac{{α}_{Z} * {ζ}_{1} + {α}_{F} * {ζ}_{2} + {α}_{R} * {ζ}_{3}}{e}} + 1 ) ,$$

wherein, β referred to the comprehensive performance evaluation parameter of the original quality evaluation model, e referred to the natural constant, α_{Z} referred to the quality evaluation factor for accuracy indices, α_{F} referred to the quality evaluation factor for F1 score indices, α_{R} referred to the quality evaluation factor for ROC-AUC value indices, ζ₁ referred to the comprehensive performance impact weight corresponding to the given quality evaluation factor for the accuracy indices, ζ₂ referred to the comprehensive performance impact weight corresponding to the given the quality evaluation factor for F1 score indices, and ζ₃ referred to the comprehensive performance impact weight corresponding to the given the quality evaluation factor for ROC-AUC value indices.

It should be understood that the comprehensive performance evaluation parameter of the original quality evaluation model was jointly determined by the quality evaluation factor for accuracy indices, the quality evaluation factor for F1 score indices, and the quality evaluation factor for ROC-AUC value indices, and the corresponding comprehensive performance evaluation parameter increased with the increase of the quality evaluation factor for accuracy indices, the quality evaluation factor for F1 score indices, and the quality evaluation factor for ROC-AUC value indices. Wherein, the comprehensive performance impact weights corresponding to the quality evaluation factor for accuracy indices, the quality evaluation factor for F1 score indices, and the quality evaluation factor for ROC-AUC value indices would be used to improve the accuracy of the calculation results.

To be more specific, specific process of determining the update frequency of quality evaluation data of the original quality evaluation model was as follows: extracting the initial comprehensive performance evaluation parameter of the original quality evaluation model from the data update cloud platform, wherein, the initial comprehensive performance evaluation parameter referred to a preset quantized parameter used to reflect the comprehensive performance of the original quality evaluation model; then, subtracting the initial comprehensive performance evaluation parameter from the comprehensive performance evaluation parameter, and labelling the obtained difference as the performance change evaluation parameter of the original quality evaluation model, after that, comparing the performance change evaluation parameter of the original quality evaluation model with the update frequency of quality evaluation data corresponding to various performance change evaluation parameter ranges stored in the data update cloud platform, and thus the update frequency of quality evaluation data of the original quality evaluation model could be obtained.

It should be understood that in this embodiment, the performance change evaluation parameter was utilized to reflect the performance change of the original quality evaluation model by comparing its initial and comprehensive performance, then, the appropriate data update frequency would be matched to the model based on the performance change of the original quality evaluation model.

In this embodiment, the smaller the performance change evaluation parameter of the original quality evaluation model, the greater the decrease in performance of the original quality evaluation model and the corresponding data update frequency. The performance change evaluation parameter ranges of the original quality evaluation model corresponded one-to-one to the data update frequency. Thus, the data update frequency of the original quality evaluation model could be obtained by determining the performance change evaluation parameter of the original quality evaluation model.

In a specific embodiment, the data update frequency of the quality evaluation model was determined by analyzing the time-effectiveness of the performance of the quality evaluation model and the dependence of the model on specific data was reduced by regularly updating, thus, its generalization ability to different data could be improved, thereby enhancing the robustness of the model. In addition, regular updates of data would enhance the environmental adaptability of the quality evaluation model, and thus the accuracy of the product quality evaluation could be guaranteed.

Obtaining the latest quality evaluation data used to update data of the original quality evaluation model based on the historical data of product quality evaluation, then, establishing a first data sample set and a second data sample set, and screening the first data sample set; after that, labelling the selected historical data sample elements as effective historical data sample elements, and updating the data of the original quality evaluation model according to the second data sample set, and various effective historical data sample elements, as well as the update frequency of quality evaluation data, wherein, the first data sample set represents the quality evaluation data sample set stored in the original quality evaluation model, while the second data sample set represents the new quality evaluation data sample set generated after the latest update of the data by the original quality evaluation model;

It should be understood that the historical data of product quality evaluation described herein was the data obtained by evaluating the product quality through the original quality evaluation model, i.e. the product quality evaluation data generated from the latest data update to the current data update, including the model evaluation results, the time for generating model evaluation results, the users evaluation results, and the user membership geographical ranges, of various products. Then, the model evaluation results and the user evaluation results of various products were integrated into one sample element, and the set of all sample elements of the product quality evaluation historical data was labeled as the second data sample set.

In this embodiment, the latest quality evaluation data used to update data of the original quality evaluation model referred to the product quality evaluation data stored in the model before the latest data update. In addition, the extraction of sample elements would be implemented to the latest quality evaluation data used to update data of the original quality evaluation model. After that, these sample elements were respectively labeled as historical data sample elements, and the set of all historical data sample elements was labeled as the first data sample set.

It should be understood that, in terms of temporal relationships, the sample elements in the first data sample set were extracted before the latest update of the model, and the sample elements in the second data sample set were extracted from the latest data update to the current data update.

It should be understood that the current data update referred to updating the original quality evaluation model by utilizing sample elements of the second data sample set and various effective historical data sample elements according to the update frequency of data.

To be more specific, the specific process of screening the first data sample set was as follows: dividing the first data sample set and the second data sample set according to the preset geographical ranges, and obtaining the collection membership geographical ranges of various historical data sample elements and the number of new data sample elements within each geographical range, and thus the specificity evaluation indices of various historical data sample elements were obtained through processing.

In a specific embodiment, in addition to obtaining the specificity evaluation indices of various historical data sample elements by analyzing and evaluating the historical data sample elements through quality management systems or data analysis tools, the specificity evaluation indices for specific fields also could be obtained based on industry analysis reports and market research reports. Furthermore, such the specificity evaluation indices could be obtained through the following calculation methods. The specific calculation expression for the specificity evaluation indices of various historical data sample elements was:

$${δ}_{i} = {( \frac{1}{e} )}^{\sqrt{\frac{{N}_{i \to D}}{{N}_{0 \to D}} * τ}} ,$$

wherein, δᵢ referred to the specificity evaluation index of the i^{th} historical data sample element, N_{i→D} referred to the number of data samples within the geographical range to which the i^{th} historical data sample element belonged, N_{0→D} referred to the number of reference data samples within the preset geographical ranges, and τ referred to the specificity evaluation impact factor corresponding to the given number of geographical range samples.

It should be understood that the specificity evaluation indices of historical data sample elements were determined by the number of data samples within the geographical range corresponding to the historical data sample element. In addition, the fewer the number of data samples within the geographical range to which a certain historical data sample element belonged, the less substitutable the historical data sample element, while the corresponding specificity evaluation index of the historical data sample element became larger. Moreover, the specificity evaluation impact factor corresponding to the number of geographical range samples utilized in the formula could improve the accuracy of calculation results.

Collecting the interval durations since the acquisition time of various historical data sample elements till the current quality evaluation data update, and labelling them as the time span among those historical data sample elements, after that, conducting a comprehensive analysis to obtain the weight indices for screening the said historical data sample elements.

The weight indices for screening historical data sample elements are a quantized evaluation data generated by analyzing the specificity and time-effectiveness of historical data sample elements. It can be used to quantitatively evaluate the dependence of the model on historical data sample elements and the importance of historical data sample elements, thereby providing data basis for screening the first data sample set.

In a specific embodiment, in addition to supporting machine learning algorithms such as decision trees, random forests, gradient boosting machines, etc., which can provide importance scores of historical data sample elements for model prediction, the weight indices for screening historical data sample elements also could evaluate the importance during the process of model training through observing the coefficient size of features and the contribution degrees, etc. Alternatively, these indices could provide explanations for the impact of each feature in model predictions by utilizing explanatory tools such as LIME (Local Interpretable Model-agnostic Explanation) and SHAP (SHapley Additive explanations). The weight indices for screening each historical data sample element could also be obtained through the following calculation method:

$${χ}_{i} = ln [ {( \frac{1}{e} )}^{\sqrt{\frac{1}{{δ}_{i} * {ψ}_{1}} + {T}_{i} * {ψ}_{2}}} + 1 ] ,$$

wherein, χᵢ referred to the weight index for screening the i^{th} historical data sample element, δᵢ referred to the specificity evaluation index of the i^{th} historical data sample element, Tᵢ referred to the time span of the i^{th} historical data sample element, ψ₁ referred to the screening weight impact factor corresponding to the given specificity evaluation index of the historical data sample element, ψ₂ referred to the weight impact factor for screening per unit corresponding to the given time span of the historical data sample element, i referred to the serial number of each historical data sample element, i.e., 1=1,2,3, . . . , n and n referred to the total number of historical data sample elements.

It should be understood that the weight indices for screening historical data sample elements were jointly determined by the specificity evaluation indices of historical data sample elements and the time span between historical data sample elements. The larger the specificity evaluation index of historical data sample element, the shorter the time span between the historical data sample elements, indicating the importance of such historical data sample element, while the corresponding weight index for screening historical data sample element got larger. The importance of historical data sample elements was revealed based on their substitutability and time span. The lower the substitutability of historical data sample elements, the shorter the time needed for collection, thereby increasing the importance of these elements.

Comparing the weight indices for screening various historical data sample elements with the preset threshold for screening weight indices of historical data sample elements. If certain weight index for screening historical data sample elements is less than the threshold for screening weight indices of historical data sample elements, the historical data sample element corresponding to such weight index for screening historical data sample elements shall be deleted. Otherwise, if a weight index for screening historical data sample elements is greater than or equal to the threshold for screening weight indices of historical data sample elements, the historical data sample element corresponding to such weight index for screening historical data sample elements shall be retained.

In a specific embodiment, by analyzing the specificity and time-effectiveness of historical data sample elements of the model, a basis was provided for updating the first data sample set of the model. In addition, by updating historical data, the risk of overfitting to existing data was reduced, making the model more flexible and adaptable to new data distributions.

Labelling the updated quality evaluation model as a new quality evaluation model and conducting model performance testing to determine the effectiveness evaluation results of the quality evaluation data update.

To be more specific, the model performance testing was conducted to determine the effectiveness evaluation results of quality evaluation data updates. The specific process was as follows: conducting performance tests on the original quality evaluation model and the new quality evaluation model respectively, and thus the accuracy rates, the F1 scores, and the ROC-AUC values of the original quality evaluation model and the new quality evaluation model were obtained. After that, the comprehensive performance reference indices of the original model and the new model could be generated through processing.

In a specific embodiment, the comprehensive performance of the quality evaluation model not only supported balancing the predictive capabilities of the model and the risk of overfitting by analyzing the complexity of the model, evaluating the number of model parameters, and the structural complexity of the model, but also could be utilized to evaluating the interpretability of model decisions based on some indices, such as conducting analysis on SHAP values (SHapley Additive explanations). It could also be obtained through the following calculation method, wherein, the calculation expression of the comprehensive performance reference index of the original model was:

$${φ}_{J} = lg ( \sqrt{\frac{{Acc}_{J} * {ς}_{1} + F {1}_{J} * {ς}_{2} + {AUC}_{J} * {ς}_{3}}{e}} + 1 ) ,$$

and the calculation expression of the comprehensive performance reference index of the new model was:

$${φ}_{X} = lg ( \sqrt{\frac{{Acc}_{X} * {ϛ}_{1} + F {1}_{X} * {ϛ}_{2} + {AUC}_{X} * {ϛ}_{3}}{e}} + 1 ) ,$$

wherein, ϕ_{J} referred to the comprehensive performance reference index of the original model, Acc_{J} referred to the accuracy rate of the original quality evaluation model, F1_{J} referred to the F1 score of the original quality evaluation model, AUC_{J} referred to the ROC-AUC value of the original quality evaluation model, ϕ_{X} referred to the comprehensive performance reference index of the new model, Acc_{X} referred to the accuracy rate of the new quality evaluation model, F1_{X} referred to the F1 score of the new quality evaluation model, AUC_{X} referred to the ROC-AUC value of the new quality evaluation model, ζ₁ referred to the comprehensive performance impact factor corresponding to the given accuracy rate, ζ₂ referred to the comprehensive performance impact factor corresponding to the given F1 score, and ζ₃ referred to the comprehensive performance impact factor corresponding to the given ROC-AUC value.

Extracting comprehensive performance critical evaluation index of the new model from the data update cloud platform, then, comparing the comprehensive performance reference index of the new model with the comprehensive performance reference index of the original model and the comprehensive performance critical evaluation index of the new model respectively. If the comprehensive performance reference index of the new model is less than the comprehensive performance reference index of the original model, or if the comprehensive performance reference index of the new model is less than the comprehensive critical evaluation index of the new model performance, the data update will be determined as failed, and the quality evaluation data of the original quality evaluation model shall be re-updated, if the comprehensive performance reference index of the new model is greater than or equal to the comprehensive performance reference index of the original model and the comprehensive performance critical evaluation index of the new model, the data update will be determined as successful, and the comprehensive performance reference index of the new model shall minus the comprehensive performance reference index of the original model and the comprehensive performance critical evaluation index of the new model, respectively, to thus the effectiveness evaluation index of data update can be obtained through analysis.

In a specific embodiment, the effectiveness evaluation index of data update could not only obtain detailed information about model performance changes by analyzing the performance of the updated model on the confusion matrix, but also analyze cases of model prediction errors before or after the update to determine whether the errors have been reduced. It could also be obtained through the following calculation method, consisting of labelling the difference between the comprehensive performance reference index of the new model and the comprehensive performance reference index of the original model, as well as the performance critical evaluation index of the new model comprehensive as the performance improvement difference ϕ̅_{T} and the performance warning difference ϕ̅_{Y}, respectively. The specific calculation expression of the effectiveness evaluation index of data update was:

$$ϕ = {e}^{\sqrt{{\overline{φ}}_{T} * {σ}_{1} + {\overline{φ}}_{Y} * {σ}_{2}}} ,$$

wherein, φ referred to the effectiveness evaluation index of data update, σ₁referred to the update effectiveness impact factor corresponding to the given performance improvement difference, and σ₂ referred to the update effectiveness impact factor corresponding to the given performance warning difference.

It should be understood that, under ideal conditions, the performance of the model after data update should not be lower than the critical model performance, but higher than the model performance before data update. By comparing the difference in model performance, the effectiveness of data update could be analyzed.

To be more specific, the effectiveness evaluation index of data update was a quantized evaluation data generated by comparing and analyzing the model performance after data updating with the model performance prior to data updating and the reference model performance. It could be utilized to evaluate the effectiveness of the model data, thus providing data basis for the inspection and analysis of data updates.

Comparing the effectiveness evaluation index of data update with the preset threshold of effectiveness evaluation indices of data update. If the effectiveness evaluation index of data update is greater than or equal to the threshold of effectiveness evaluation indices of data update, labelling the current effectiveness evaluation result of data update as an effective update. Otherwise, if the effectiveness evaluation index of data update is less than the threshold of effectiveness evaluation indices of data update, labelling the current effectiveness evaluation result of data update as an ineffective update.

In a specific embodiment, the effectiveness of the quality evaluation data updates was evaluated by analyzing the comprehensive performance of the quality evaluation model after data updates, thereby guaranteeing further optimization and iteration of the model by evaluating the effectiveness of data updates, and further improving the performance and accuracy of the model. In addition, if the data updates caused performance degradation, the update strategy could be timely rolled back or re-evaluated to reduce potential risks.

In a specific embodiment, the present invention provided a method for constructing a quality evaluation data update model based on convolutional neural networks. By analyzing the time-effectiveness of the performance of the quality evaluation model, this method could determine the data update frequency of the quality evaluation model and update the data samples in the model, as well as evaluate the effectiveness of the updated quality evaluation data by analyzing the comprehensive performance of the quality evaluation model after the data update. In addition, it allowed for further optimization and iteration of the model through evaluating the effectiveness of the data update, thereby improving its performance and accuracy.

The foregoing is only an example and illustration of the construction of the present invention. Those skilled in the art may make various modifications or additions to the individual embodiment described, or replace it in a similar way. As long as they do not deviate from the structure of the invention, or exceed the limits defined in the present claims, they shall all fall within the protection of the present invention.

1. A method for constructing a quality evaluation data update model based on a convolutional neural network, characterized in that consisting of:
collecting historical data of product quality evaluation of an original quality evaluation model, and analyzing the historical data of product quality evaluation of the original quality evaluation model, then, determining a update frequency of the quality evaluation data of the original quality evaluation model;
obtaining a latest quality evaluation data used to update data of the original quality evaluation model based on the historical data of product quality evaluation, then, establishing a first data sample set and a second data sample set, and screening the first data sample set; after that, labelling a selected historical data sample elements as effective historical data sample elements, and updating the data of the original quality evaluation model according to the second data sample set, and various effective historical data sample elements, as well as the update frequency of quality evaluation data, wherein, the first data sample set represents the quality evaluation data sample set stored in the original quality evaluation model, while the second data sample set represents a new quality evaluation data sample set generated after the latest update of the data by the original quality evaluation model;
labelling the updated quality evaluation model as a new quality evaluation model and conducting model performance testing to determine effectiveness evaluation results of the quality evaluation data update;
a specific analysis process for analyzing the historical data of product quality evaluation of the original quality evaluation model is as follows:
deriving accuracy rates, F1 scores, and ROC-AUC values of the original quality evaluation model in each period through processing based on the historical data of product quality evaluation from the original quality evaluation model, including predicted and actual results of product quality evaluation;
conducting regression analysis on the accuracy rates, the F1 scores, and the ROC-AUC values of the original quality evaluation model in each period to derive the quality evaluation factor for accuracy indices, the quality evaluation factor for F1 score indices, and the quality evaluation factor for ROC-AUC value indices, respectively;
obtaining the comprehensive performance evaluation parameter of the original quality evaluation model through comprehensive analysis;
the specific process of determining the update frequency of quality evaluation data of the original quality evaluation model is as follows:
extracting an initial comprehensive performance evaluation parameter of the original quality evaluation model from a data update cloud platform, subtracting the initial comprehensive performance evaluation parameter from the comprehensive performance evaluation parameter, and labelling the obtained difference as the performance change evaluation parameter of the original quality evaluation model;
comparing the performance change evaluation parameter of the original quality evaluation model with the update frequency of quality evaluation data corresponding to various performance change evaluation parameter ranges stored in the data update cloud platform, and thus the update frequency of quality evaluation data of the original quality evaluation model is obtained;
a specific process of screening the first data sample set is as follows:
dividing the first data sample set and the second data sample set according to preset geographical ranges, and obtaining collection membership geographical ranges of various historical data sample elements and a number of new data sample elements within each geographical range, and thus specificity evaluation indices of various historical data sample elements are obtained through processing;
collecting interval durations since acquisition time of various historical data sample elements till current quality evaluation data update, and labelling them as a time span among those historical data sample elements, after that, conducting a comprehensive analysis to obtain weight indices for screening the said historical data sample elements;
comparing the weight indices for screening various historical data sample elements with a preset threshold for screening weight indices of historical data sample elements, if certain weight index for screening historical data sample elements is less than the threshold for screening weight indices of historical data sample elements, the historical data sample element corresponding to such weight index for screening historical data sample elements shall be deleted, otherwise, if a weight index for screening historical data sample elements is greater than or equal to the threshold for screening weight indices of historical data sample elements, the historical data sample element corresponding to such weight indices for screening historical data sample elements shall be retained.

2. The method for constructing a quality evaluation data update model based on convolutional neural networks according to claim 1, characterized in that:
conducting model performance testing to determine the effectiveness evaluation results of the quality evaluation data updates, the specific process is as follows:
conducting performance tests on the original quality evaluation model and the new quality evaluation model respectively, and thus the accuracy rates, the F1 scores, and the ROC-AUC values of the original quality evaluation model and the new quality evaluation model are obtained, after that, comprehensive performance reference indices of the original model and the new model can be generated through processing;
extracting comprehensive performance critical evaluation index of the new model from the data update cloud platform, then, comparing the comprehensive performance reference index of the new model with the comprehensive performance reference index of the original model and the comprehensive performance critical evaluation index of the new model respectively, if the comprehensive performance reference index of the new model is less than the comprehensive performance reference index of the original model, or if the comprehensive performance reference index of the new model is less than the comprehensive critical evaluation index of the new model performance, the data update will be determined as failed, and the quality evaluation data of the original quality evaluation model shall be re-updated, if the comprehensive performance reference index of the new model is greater than or equal to the comprehensive performance reference index of the original model and the comprehensive performance critical evaluation index of the new model, the data update will be determined as successful, and the comprehensive performance reference index of the new model shall minus the comprehensive performance reference index of the original model and the comprehensive performance critical evaluation index of the new model, respectively, to thus an effectiveness evaluation index of data update can be obtained through analysis;
comparing the effectiveness evaluation index of data update with the preset threshold of effectiveness evaluation indices of data update, if the effectiveness evaluation index of data update is greater than or equal to the threshold of effectiveness evaluation indices of data update, labelling the current effectiveness evaluation result of data update as an effective update, otherwise, if the effectiveness evaluation index of data update is less than the threshold of effectiveness evaluation indices of data update, labelling the current effectiveness evaluation result of data update as an ineffective update.

3. The method for constructing a quality evaluation data update model based on convolutional neural networks according to claim 1, characterized in that the comprehensive performance evaluation parameter of the original quality evaluation model is a quantized evaluation data generated by analyzing the quality evaluation factor for accuracy indices, the quality evaluation factor for F1 score indices, and the quality evaluation factor for ROC-AUC value indices, it can be used to quantitatively evaluate the time-effectiveness of the model performance in terms of accuracy rate, F1 score, and ROC-AUC value, thus providing data basis for determining the data update frequency of the model.

4. The method for constructing a quality evaluation data update model based on convolutional neural networks according to claim 1, characterized in that: the weight indices for screening historical data sample elements are a quantized evaluation data generated by analyzing the specificity and time-effectiveness of historical data sample elements, it can be used to quantitatively evaluate the dependence of the model on historical data sample elements and the importance of historical data sample elements, thereby providing data basis for screening the first data sample set.

5. The method for constructing a quality evaluation data update model based on convolutional neural networks according to claim 2, characterized in that: the effectiveness evaluation index of data update is a quantized evaluation data generated by comparing and analyzing the model performance after data updating with the model performance prior to data updating and the reference model performance, it can be utilized to evaluate the effectiveness of the model data, thus providing data basis for the inspection and analysis of data updates.

6. The method for constructing a quality evaluation data update model based on convolutional neural networks according to claim 1, characterized in that the computation expression for the comprehensive performance evaluation parameter of the original quality evaluation model is as follows:
$$β = {log}_{2} ( \sqrt{\frac{{α}_{Z} * {ζ}_{1} + {α}_{F} * {ζ}_{2} + {α}_{R} * {ζ}_{3}}{e}} + 1 ) ,$$
wherein, β refers to the comprehensive performance evaluation parameter of the original quality evaluation model, e refers to the natural constant, α_{Z} refers to the quality evaluation factor for accuracy indices, α_{F} refers to the quality evaluation factor for F1 score indices, α_{R} refers to the quality evaluation factor for ROC-AUC value indices, ζ₁ refers to the comprehensive performance impact weight corresponding to the given quality evaluation factor for the accuracy indices, ζ₂ refers to the comprehensive performance impact weight corresponding to the given the quality evaluation factor for F1 score indices, and ζ₃ refers to the comprehensive performance impact weight corresponding to the given the quality evaluation factor for ROC-AUC value indices.

7. The method for constructing a quality evaluation data update model based on convolutional neural networks according to claim 1, characterized in that the computation expression for the weight indices for screening various historical data sample elements is as follows:
$${χ}_{i} = ln [ {( \frac{1}{e} )}^{\sqrt{\frac{1}{{δ}_{i} * {ψ}_{1}} + {T}_{i} * {ψ}_{2}}} + 1 ] ,$$
wherein, χᵢ refers to the weight index for screening the i^{th} th historical data sample element, δᵢ refers to the specificity evaluation index of the i^{th} historical data sample element, Tᵢ refers to the time span of the i^{th} historical data sample element, ψ₁ refers to the weight impact factor for screening corresponding to the given specificity evaluation index of the historical data sample element, ψ₂ refers to the screening weight impact factor per unit corresponding to the given time span of the historical data sample element, 1 refers to the serial number of each historical data sample element, i.e., i=1,2,3, . . . , n and n refers to the total number of historical data sample elements.
